(19) United States
(12) Patent Application Publication
(10) Pub. No.: US 2026/0340383 A1
(43) Pub. Date: Oct. 29, 2026

(54) TRAINING DATA QUALITY EVALUATION DEVICE, TRAINING DATA QUALITY EVALUATION METHOD, AND TRAINING DATA QUALITY EVALUATION SYSTEM

(71) Applicant: Hitachi, Ltd., Tokyo (JP)

(72) Inventors: Ekant Muljibhai AMIN, Tokyo (JP); Yuta KOREEDA, Tokyo (JP)

(21) Appl. No.: 19/532,072

(22) Filed: Feb. 6, 2026

(30) Foreign Application Priority Data
Apr. 28, 2025 (JP) 2025-074420

(51) Int. Cl. G06N 3/08

(52) U.S. Cl. CPC G06N 3/08

(57) ABSTRACT

A training data quality evaluation device includes a processor and a memory storing a program to be executed by the processor, in which the processor is configured to: identify a data quality for each segment included in training data; generate an additionally trained model by additionally training a large language model using the training data; generate a question and a correct answer using each segment, and associate the question with the data quality of the segment used to generate the question; and cause the additionally trained model to output an answer to the question, perform scoring by comparing the answer with the correct answer, and create a summary of the scoring.

### CROSS-REFERENCE TO PRIOR APPLICATION

This application relates to and claims the benefit of priority from Japanese Patent Application number 2025-074420, filed on Apr. 28, 2025 the entire disclosure of which is incorporated herein by reference.

### BACKGROUND OF THE INVENTION

### 1.Technical Field

The present invention relates to a training data quality evaluation device, a training data quality evaluation method, and a training data quality evaluation system.

### 2. DESCRIPTION OF THE RELATED ART

In recent years, large language models (LLMs) are used in various social situations. Generally provided LLMs are general-purpose LLMs to which usage scenes or application fields are not applied. On the other hand, domain-specific LLMs limited to particular usage scenes and application scenes are useful for solving domain-specific problems. CN 117272011 A discloses a method using an LLM-as-a-judge technique, in which another LLM is used to evaluate the performance of a target LLM.

Patent Literature 1: CN 117272011 A

### SUMMARY OF THE INVENTION

In the invention described in CN 117272011 A, training data cannot be evaluated.

A training data quality evaluation device according to a first aspect of the present invention is a training data quality evaluation device including a processor and a memory storing a program to be executed by the processor, in which the processor is configured to: identify a data quality for each segment included in training data; generate an additionally trained model by additionally training a large language model using the training data; generate a question and a correct answer using each segment, and associate the question with the data quality of the segment used to generate the question; and cause the additionally trained model to output an answer to the question, perform scoring by comparing the answer with the correct answer, and create a summary of the scoring.

A training data quality evaluation method according to a second aspect of the present invention is a training data quality evaluation method executed by a training data quality evaluation device including a processor and a memory storing a program to be executed by the processor, the training data quality evaluation method including: identifying a data quality for each of segments included in training data; generating an additionally trained model by additionally training a large language model using the training data; generating a question and a correct answer using each segment, and associating the question with the data quality of the segment used to generate the question; and causing the additionally trained model to output an answer to the question, performing scoring by comparing the answer with the correct answer, and creating a summary of the scoring.

A training data quality evaluation system according to a third aspect of the present invention is a training data quality evaluation system including a processor and a memory storing a program to be executed by the processor, in which the processor is configured to: identify a data quality for each segment included in training data; generate an additionally trained model by additionally training a large language model using the training data; generate a question and a correct answer using each segment, and associate the question with the data quality of the segment used to generate the question; and cause the additionally trained model to output an answer to the question, perform scoring by comparing the answer with the correct answer, and create a summary of the scoring.

According to the present invention, training data can be evaluated.

### BRIEF DESCRIPTION OF THE DRAWINGS

FIG. 1 is a hardware configuration diagram of a computer system that realizes a training data quality evaluation device;

FIG. 2 is a diagram illustrating an example of a configuration of a training data quality evaluation system;

FIG. 3 is a diagram illustrating an outline operation of a training data quality evaluation application in a first embodiment;

FIG. 4 is a diagram illustrating a detailed operation of the training data quality evaluation application in the first embodiment;

FIG. 5 is a diagram illustrating an outline of processing performed by a scoring device;

FIG. 6 is a diagram illustrating an example of an evaluation score displayed by an evaluation display unit;

FIG. 7 is a flowchart illustrating processing of the data quality evaluation application;

FIG. 8 is a diagram illustrating a display provided by the evaluation display unit in a third modification;

FIG. 9 is a diagram illustrating a display provided by the evaluation display unit in a fourth modification;

FIG. 10 is a diagram illustrating an example of a configuration of a training data quality evaluation system in a second embodiment;

FIG. 11 is a diagram illustrating an outline operation of a training data quality evaluation application in the second embodiment;

FIG. 12 is a diagram illustrating a detailed operation of the training data quality evaluation application in the second embodiment;

FIG. 13 is a diagram illustrating an example of a prompt editing GUI; and

FIG. 14 is a flowchart illustrating processing of the data quality evaluation application in the second embodiment.

### DETAILED DESCRIPTION

### First Embodiment

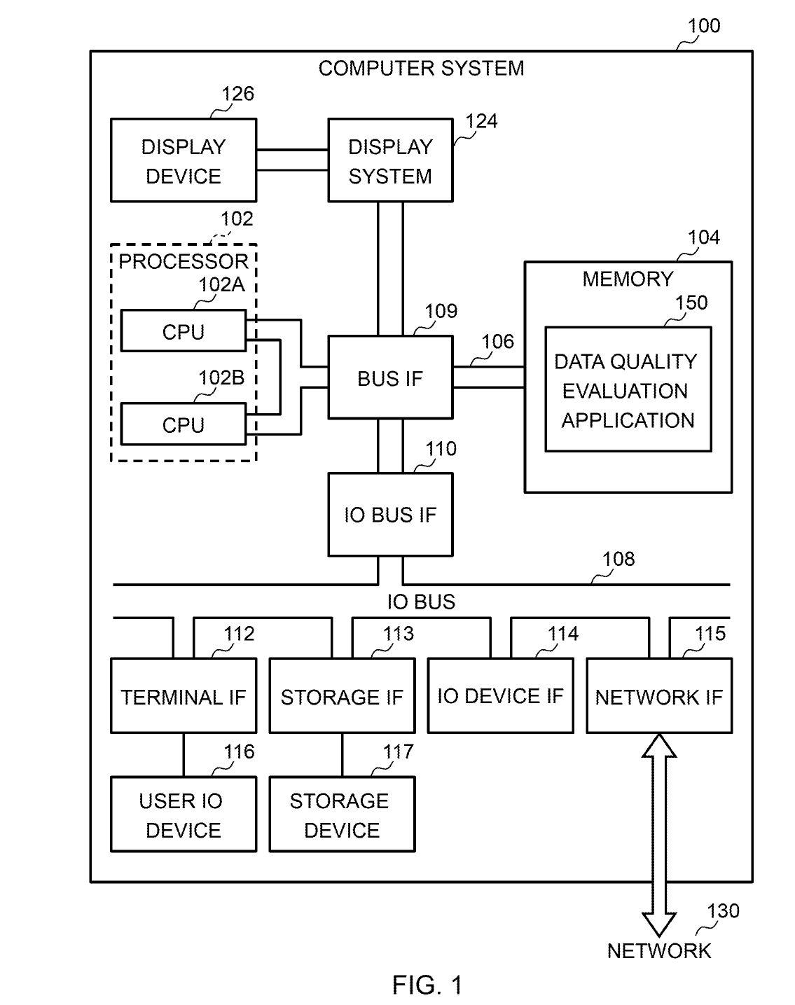

Hereinafter, a training data quality evaluation device according to a first embodiment will be described with reference to FIGS. 1 to 7.

FIG. 1 is a hardware configuration diagram of a computer system 100 that realizes a training data quality evaluation device. The computer system 100 includes one or more processors 102, a memory 104, a terminal IF 112, a storage IF 113, an input/output (IO) IF 114, and a network IF 115. In the present embodiment, the interface is also referred to as "IF". These components may be connected to each other via a memory bus 106, an IO bus 108, a bus IF unit 109, and an IO bus IF unit 110.

The computer system 100 may include one or more general-purpose programmable central processing units (CPUs) 102A and 102B, which are collectively referred to as processors 102 herein. In some embodiments, the computer system 100 may include multiple processors, and in other embodiments, the computer system 100 may be a single-CPU system. Each processor 102 executes an instruction stored in the memory 104. Each processor 102 may include an on-board cache.

In some embodiments, the memory 104 may include a random access semiconductor memory, a storage device, or a storage medium (either volatile or non-volatile) for storing data and programs. The memory 104 may store all or some of the programs, modules, and data structures that perform the functions described herein. For example, the memory 104 may store a data quality evaluation application 150. In some embodiments, the data quality evaluation application 150 may include instructions or statements for performing the functions to be described below on the processor 102.

In some embodiments, the data quality evaluation application 150 may be implemented in hardware via semiconductor devices, chips, logic gates, circuits, circuit cards, and/or other physical hardware devices instead of or in addition to a processor-based system. In some embodiments, the data quality evaluation application 150 may include data other than instructions or statements. In some embodiments, a camera, sensor, or another data input device (not illustrated) may be provided to communicate directly with the bus IF unit 109, the processors 102, or other hardware of the computer system 100.

The computer system 100 may include a bus IF unit 109 for communication between the processors 102, the memory 104, the display system 124, and the IO bus IF unit 110. The IO bus IF unit 110 can be coupled with the IO bus 108 to transfer data between various IO units. The IO bus IF unit 110 can communicate with a plurality of IF units 112, 113, 114, and 115, which are also known as IO processors or IO adapters, via the IO bus 108.

The display system 124 may include a display controller, a display memory, or both. The display controller may provide video, audio, or both types of data to the display device 126. The computer system 100 can also include one or more devices such as sensors configured to collect data and provide the data to the processors 102. For example, the computer system 100 may include biometric sensors that collect heart rate data, stress level data, and the like, environmental sensors that collect humidity data, temperature data, pressure data, and the like, and motion sensors that collect acceleration data, movement data, and the like. The display system 124 can be connected to the display device 126 such as a single display screen, a television, a tablet, or a mobile device.

The IO interface unit can communicate with various storage devices and IO devices. For example, the terminal IF 112 supports attachment of user IO devices 116 including user output devices such as a video display device, a speaker, and a television, and user input devices such as a keyboard, a mouse, a keypad, a touchpad, a trackball, a button, a light pen, and other pointing devices. A user can operate a user input device using a user interface to enter input data and instructions into the user IO device 116 and the computer system 100 and receive output data from the computer system 100. The user interface may be presented, via the user IO device 116, to be displayed on the display device 126, reproduced through a speaker, or printed through a printer.

The storage IF 113 supports attachment of one or more storage devices 117. The storage device 117 is typically a magnetic disk drive, but may also be an array of multiple disk drives or other storage devices configured to appear as a single disk drive. In some embodiments, the storage device 117 can be implemented as any secondary storage device. The contents of the memory 104 are stored in the storage device 117, and are read out from the storage device 117 as necessary. The IO device IF 114 can provide an interface to another IO device such as a printer or a facsimile. The network IF 115 can provide a communication path so that the computer system 100 and other devices can communicate with each other. The communication path may be, for example, a network 130.

In some embodiments, the computer system 100 may be a multi-user mainframe computer system, a single-user system, a server computer that does not have a direct user interface and receives requests from other computer systems, or the like. In other embodiments, the computer system 100 may be a desktop computer, a portable computer, a notebook computer, a tablet computer, a pocket computer, a phone, a smartphone, or any other suitable electronic device.

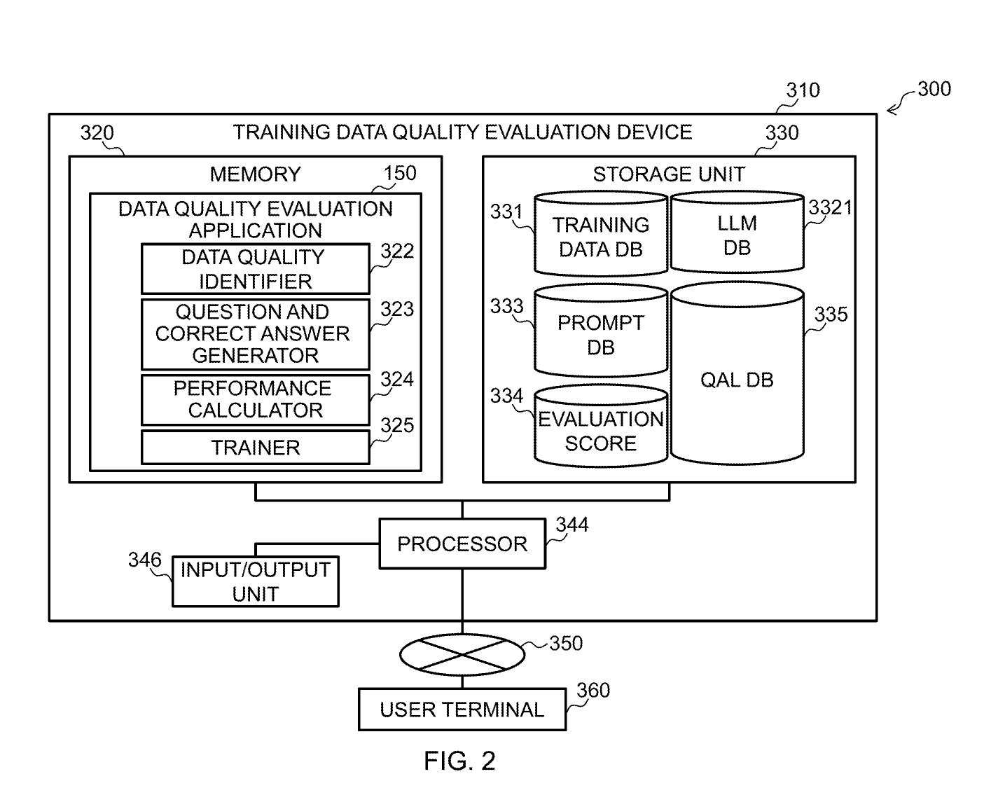

FIG. 2 is a diagram illustrating an example of a configuration of a training data quality evaluation system 300. As illustrated in FIG. 2, the training data quality evaluation system 300 includes a training data quality evaluation device 310, a communication network 350, and a user terminal 360. The training data quality evaluation device 310 may be implemented by the computer system 100 illustrated in FIG. 1. The training data quality evaluation device 310 includes a memory 320, a storage unit 330, a processor 344, and an input/output unit 346. The correspondence between the training data quality evaluation device 310 and the computer system 100 is as follows. The memory 320 corresponds to the memory 104, the storage unit 330 corresponds to the storage device 117, the processor 344 corresponds to the processor 102, and the input/output unit 346 corresponds to the user IO device 116.

The memory 320 stores the data quality evaluation application 150. The data quality evaluation application 150 includes a data quality identifier 322, a question and correct answer generator 323, a performance calculator 324, and a trainer 325. The storage unit 330 stores a training data database 331, an LLM database 3321, a prompt database 333, an evaluation score 334, and a QAL database 335. The training data database 331 stores general-purpose data 404 and domain-specific data 402, which will be described later. The LLM database 3321 stores LLMs generated by the data quality evaluation application 150.

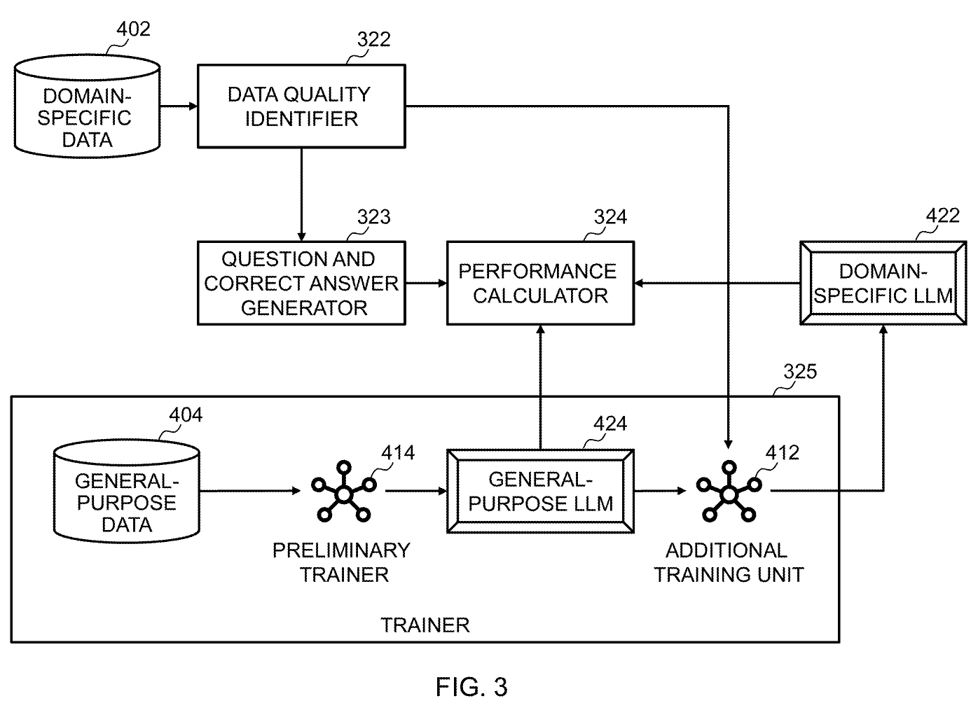

FIG. 3 is a diagram illustrating an outline operation of the data quality evaluation application 150 in the first embodiment. The domain-specific data 402 illustrated in the upper left and the general-purpose data 404 illustrated in the lower left are prepared in advance. A general-purpose LLM 424 and a domain-specific LLM 422 are generated by the trainer 325. The general-purpose data 404 is used to generate the general-purpose LLM 424. The domain- specific data 402 is used to generate the domain-specific LLM 422 and to generate questions and correct answers for evaluating the domain-specific LLM 422. This will be described in detail below.

The general-purpose data 404 includes books, documents published on the Internet, novels, news, and the like. Unlike the domain-specific data 402, the general-purpose data 404 is not limited to a specific domain and includes data in various fields. The domain-specific data 402 is data related to a specific domain. The domain-specific data 402 is not limited to text data, and may include websites, images containing characters, PDF files, and the like. The domain-specific data 402 is used for additional training as will be described later, and thus, the domain-specific data 402 is hereinafter also referred to as “training data”.

The general-purpose LLM 424 is created by a preliminary trainer 414 using the general-purpose data 404, which is enormous data. The general-purpose LLM 424 may be any of various known models, such as a Llama model, a GPT model, a Mistral model, a Gemini model, a Claude model, a Gemma model, or a Falcon model. An additional training unit 412 generates a domain-specific LLM 422 on the basis of the general-purpose LLM 424. The domain-specific LLM 422, which is a natural language model obtained by performing additional training on the general-purpose LLM 424, can also be referred to as an “additionally trained model”. The additional training unit 412 performs fine tuning, continuous preliminary training, supervised fine adjustment, or reinforcement learning. The domain-specific data 402 is processed and used by the additional training unit 412 to create the domain-specific LLM 422.

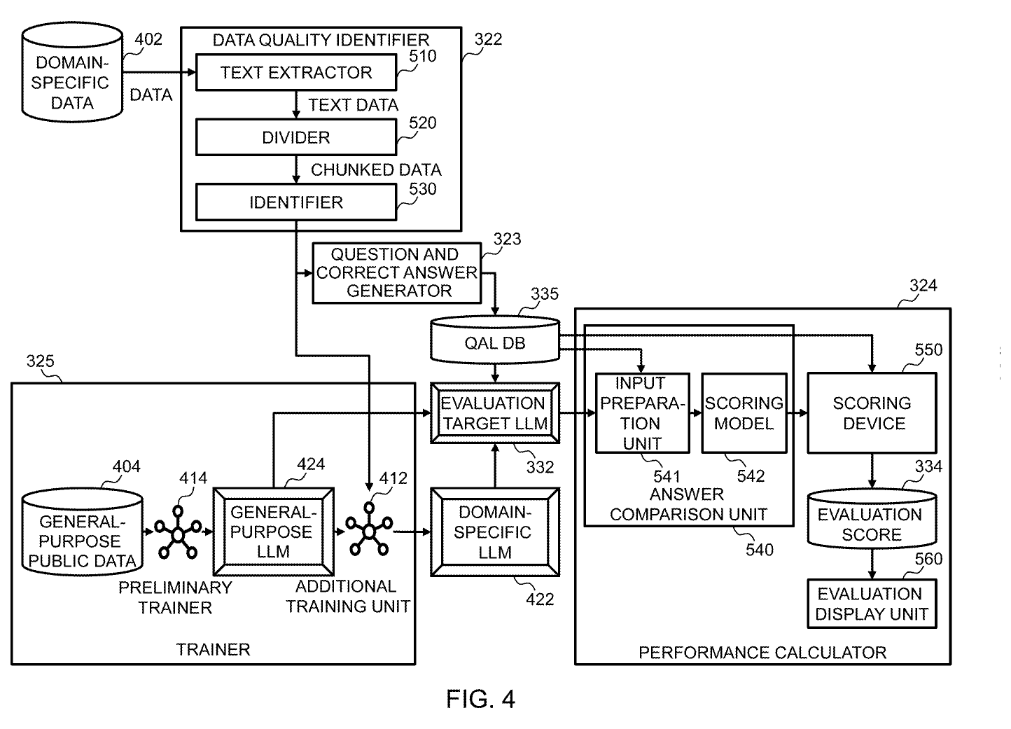

FIG. 4 is a diagram illustrating a detailed operation of the data quality evaluation application 150 in the first embodiment. The data quality identifier 322 extracts text from the domain-specific data 402, divides the extracted text into segments, and identifies a data quality for each segment. Hereinafter, the data quality for each segment identified by the data quality identifier 322 is referred to as a "data quality label". The data quality identifier 322 includes a text extractor 510, a divider 520, and an identifier 530.

The text extractor 510 extracts text data from the domain-specific data 402 that does not directly include text data, which is a processing target. For example, the text extractor 510 extracts text data from PDF files or images. The text extractor 510 is any of various known applications and libraries, for example, a PDF2text or web2text converter. However, in a case where the domain-specific data 402 directly includes textual data, the data quality identifier 322 does not need to include the text extractor 510.

The divider 520 divides the text data extracted by the text extractor 510 into appropriate lengths. Hereinafter, each piece of text data divided by the divider 520 is referred to as a "segment". However, this segment is also referred to as a "chunk" when focusing on its length. The divider 520 is, for example, a semantic chunking algorithm or LLM. The semantic chunking algorithm may be semchunk, which is a Python library. For example, the divider 520 divides a document of 100k tokens into a plurality of segments of 10k tokens. However, in a case where the domain-specific data 402 is divided into a plurality of segments in advance, the data quality identifier 322 does not need to include the divider 520.

The identifier 530 determines a data quality for each of the segments into which the divider 520 has divided the data. For example, there are two types of data quality labels: high quality and low quality. For example, it may be determined whether each segment falls into one of the four classifications: “short sentence”, “bullet point”, “repeated word”, and “natural sentence in rich context”, and the data quality of the segment may be determined as high quality only when the segment falls into “natural sentence in rich context”, and the data quality of the segment may be determined as low quality when the segment falls into another classification. Data quality labels may be classified into five types based on data features, namely, short sentence, bullet point, repeated word, natural sentence in rich context, and others. The identifier 530 may determine a data quality using a rule-based algorithm, or may determine a data quality using an LLM or a machine learning system. The output of the identifier 530 may be a segment for a data quality pair. The identifier 530 may set a data quality label for each segment output by the divider 520, or may set a data quality label for a plurality of segments.

The question and correct answer generator 323 generates questions for evaluation and correct answers corresponding to the questions. The questions are generated from the segments of the domain-specific data 402 output by the divider 520. As described above, a data quality label is attached to each segment by the identifier 530. A question generated using a certain segment is labeled with the data quality label attached to the segment. The questions and answers are generated by an LLM or a machine learning system. Note that the data quality labels attached to the questions may be newly created by any of the LLM system, the machine learning system, and the rule-based system. The questions, answers, and data quality labels generated by the question and correct answer generator 323 are stored in the QAL database 335.

The performance calculator 324 measures performances of LLMs trained using different training data. Specifically, the performance calculator 324 measures performances of the general-purpose LLM 424 and the domain-specific LLM 422. The general-purpose LLM 424 is trained using the general-purpose data 404. The general-purpose LLM 424 serves as a baseline for performance comparison. Since the questions generated by the question and correct answer generator 323 are generated from the domain-specific data 402, the general-purpose LLM 424, which does not use the domain-specific data 402 when trained, may be measured to have poor performance. The main purpose of the performance calculator 324 is to evaluate the domain-specific LLM 422 that has been additionally trained using the domain-specific data 402. The performance calculator 324 evaluates the training data quality of the domain-specific data 402 by evaluating the domain-specific LLM 422.

The performance calculator 324 includes an answer comparison unit 540, a scoring device 550, and an evaluation display unit 560. The answer comparison unit 540 includes an input preparation unit 541 and a scoring model 542. The input preparation unit 541 inputs an answer output from an evaluation target LLM 332 and a correct answer output from the QAL database 335 to the scoring model 542. The evaluation target LLM 332 refers to the general-purpose LLM 424 and the domain-specific LLM 422.

The QAL database 335 stores a plurality of combinations of question, correct answer, and data quality label. The QAL database 335 outputs each of the question, the correct answer, and the data quality label stored in association to the evaluation target LLM 332, the input preparation unit 541, and the scoring device 550. The evaluation target LLM 332 outputs an answer to the input question to the input preparation unit 541. The correct answer is provided to the scoring model 542 via the input preparation unit 541. Note that, although referred to as a "database" herein for convenience, a calculation unit that outputs data stored in the QAL database 335 to the evaluation target LLM 332, the input preparation unit 541, and the scoring device 550 may be included in the QAL database 335. This calculation unit is also realized by the processor 102.

The scoring model 542 is realized by, for example, an LLM-as-a-judge or a similarity score generator. For example, in a case where the scoring model 542 is realized via an LLM-as-a-judge, the scoring model 542 is a large language model different from the general-purpose LLM 424 and the domain-specific LLM 422. The similarity score generator may be, for example, an embedding-based comparison such as a BERT score, a BLEU score, or a BLEURT score. Based on the scoring model 542, the input preparation unit 541 may include preparation of prompts or normalization of text. The output of the input preparation unit 541 may include identification of evaluation criteria of the scoring model 542, such as domain relevance, correctness, or fluency. The scoring model 542 generates scores according to the evaluation criteria specified by the input preparation unit 541. The scores generated from the answer comparison unit 540 are provided together with the respective questions and data quality labels as inputs to the scoring device 550.

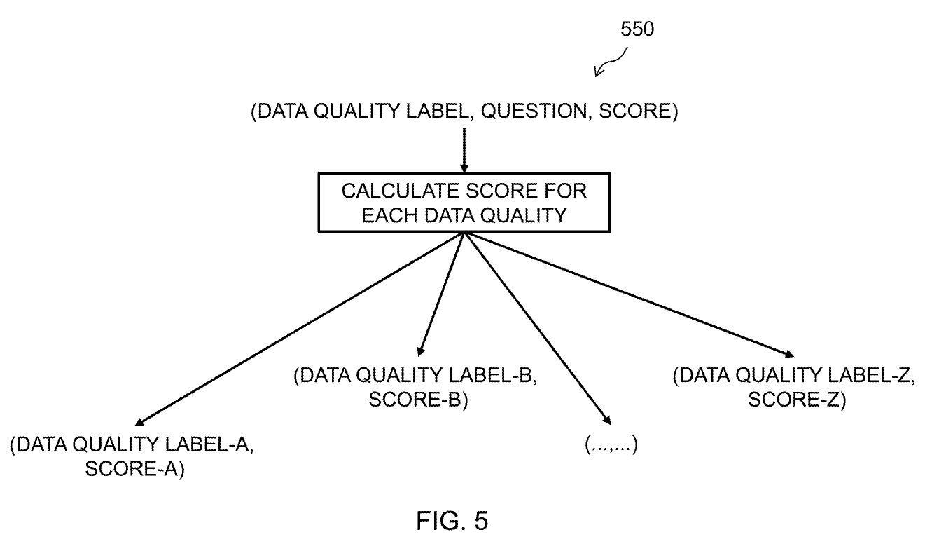

FIG. 5 is a diagram illustrating an outline of processing performed by the scoring device 550. A score is generated by the answer comparison unit 540 for each combination of question and answer. The scoring device 550 summarizes the scores. For example, the scoring device 550 may calculate an average value of scores for each data quality to calculate a score for each data quality. The scoring device 550 may further weight the average value of scores for each data quality to calculate one value for the entire domain-specific data 402. These scores are summarized and saved as an evaluation score 334 based on the data quality labels. For example, scores of a plurality of questions belonging to the data quality label "high" are calculated as one scalar value, and scores of a plurality of questions belonging to the data quality label "low" are calculated as one scalar value. Then, a set of these scalar values is set as an evaluation score 334.

The evaluation score 334 is displayed on the evaluation display unit 560. The evaluation score 334 may be an average score for each data quality, or may be presented in a tabular format. The collected scores may provide a single score using a weighted summary. For example, in a case where a low quality score is more important, a weight "0.7" is set to the low quality score and a weight "0.3" is set to the high quality score to generate a single score.

The evaluation display unit 560 presents the evaluation score 334 to the user. For example, the evaluation display unit 560 may present the evaluation score 334 to the user IO device 116 via the terminal IF 112, or may present the evaluation score 334 to the user via the network IF 115 and the network 130. The evaluation display unit 560 may present the evaluation score 334 as a character, an image, or a video, or may present the evaluation score 334 by voice.

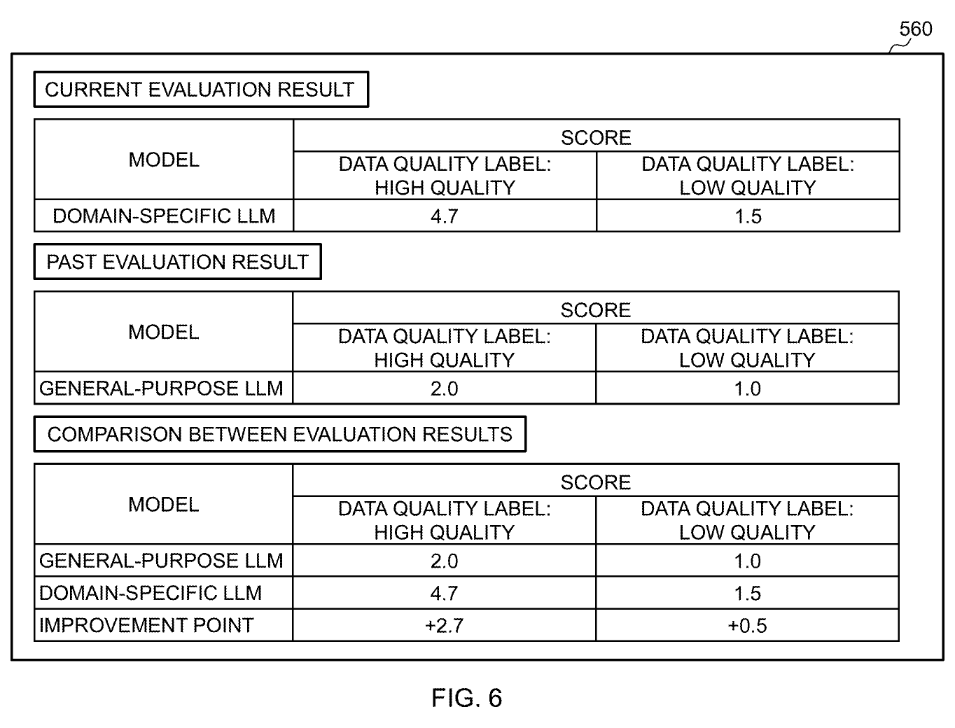

FIG. 6 is a diagram illustrating an example of the evaluation score 334 displayed by the evaluation display unit 560. In this example, a score for each data quality label is illustrated for each of the domain-specific LLM 422 and the general-purpose LLM 424. For the data quality label “high”, the general-purpose LLM 424 that has been additionally trained for the domain-specific LLM 422 shows a significant increase in score. On the other hand, for the data quality label “low”, the change in score is small. The user can see, from this result, that training regarding data with the data quality label "low" is insufficient.

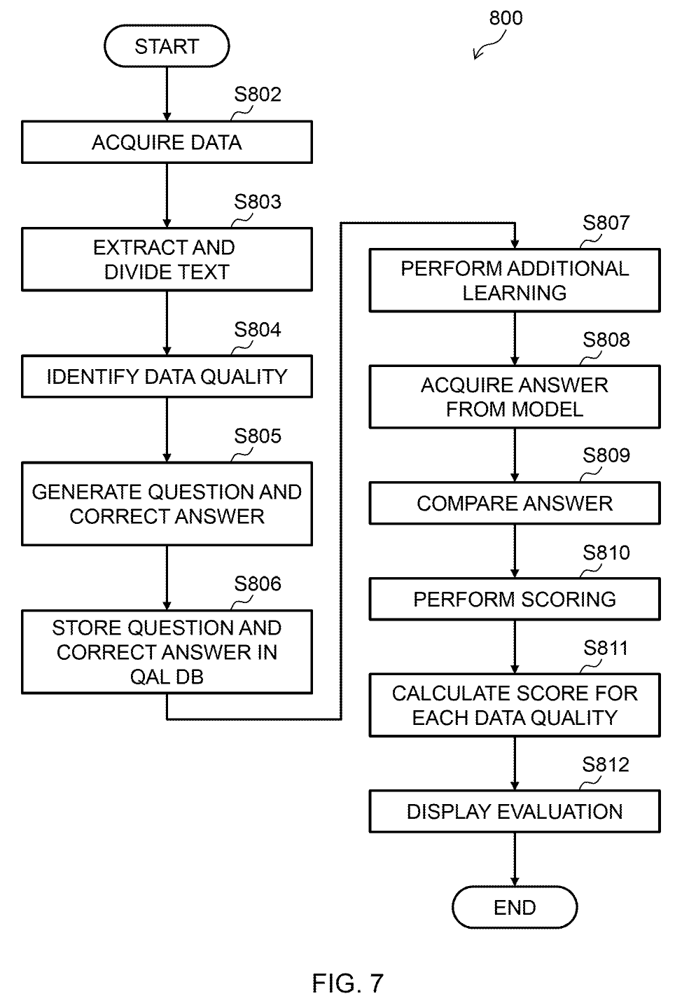

FIG. 7 is a flowchart illustrating processing of the data quality evaluation application 150. However, before this flowchart is executed, the generation of the general-purpose LLM 424 using the general-purpose data 404 is completed. First, in step S802, the data quality identifier 322 acquires domain-specific data 402. In subsequent step S803, the text extractor 510 extracts text data, and the divider 520 divides the text data into segments. In subsequent step S804, the identifier 530 identifies a data quality for each chunk.

In subsequent step S805, the question and correct answer generator 323 generates a question and a correct answer using each segment. In subsequent step S806, the question and correct answer generator 323 stores, in the QAL database 335, the question and the correct answer generated in step S805 in association with the data quality label of the segment used to generate the question. In subsequent step S807, the additional training unit 412 performs additional training using the segments into which the divider 520 has divided the text data to generate a domain-specific LLM 422.

In subsequent step S808, the input preparation unit 541 acquires an answer from a model, that is, an evaluation target LLM 332. The details are as follows. First, the evaluation target LLM 332 is each of the general-purpose LLM 424 and the domain-specific LLM 422 as described above. When the question generated in step S805 is input to the evaluation target LLM 332, the evaluation target LLM 332 outputs an answer, and accordingly, the input preparation unit 541 acquires this answer.

In subsequent step S809, the answer comparison unit 540 of the performance calculator 324 compares the answer output from the evaluation target LLM 332 with the correct answer created in advance, and outputs a score and the question to the scoring device 550. In subsequent step S810, the scoring device 550 performs scoring, and in subsequent step S811, the scoring device 550 calculates an evaluation score 334 for each data quality. In subsequent step S812, the evaluation display unit 560 displays an evaluation result for the user, and ends the processing illustrated in FIG. 7. Note that the process of step S807 may be executed at any time after step S803, and may be executed in parallel with steps S804 to S806.

According to the first embodiment described above, the following advantageous effects can be obtained.
(1) A training data quality evaluation device 310 includes a processor 102 and a memory 104 that stores a data quality evaluation application 150 executed by the processor 102. The processor 102 functions as an identifier 530 to identify a data quality for each of segments included in domain-specific data 402 (S804 in FIG. 7). The processor 102 generates a domain-specific LLM 422, which can also be referred to as an additionally trained model, by additionally training a large language model using the domain-specific data 402 (S807 in FIG. 7). The processor 102 functions as a question and correct answer generator 323 to generate a question and a correct answer using each of the segments (S805), and associate the question with the data quality of the segment used to generate the question (S806). The processor 102 functions as a performance calculator 324 to cause the domain-specific LLM 422 to output an answer to the question (S808), and perform scoring by comparing the answer with the correct answer, and create a summary of the scoring (S809 to S811). Therefore, the training data quality evaluation device 310 can evaluate the domain-specific data 402 by evaluating the domain-specific LLM 422 trained using the domain-specific data 402, which can also be referred to as training data.

(2) The processor 102 functions as an evaluation display unit 560 to present the summary for each data quality to the user. Therefore, the user can know the evaluation of the domain-specific data 402 for each data quality.

(3) The processor 102 functions as a text extractor 510 to generate text data from the domain-specific data 402, functions as a divider 520 to divide the text data into a plurality of segments, and functions as an identifier 530 to assign at least one data quality label indicating a data quality for each segment. Therefore, the training data quality evaluation device 310 can assign a data quality label for each segment.

(4) The processor 102 also functions as an answer comparison unit 540 to perform scoring by inputting the answer and the correct answer to the scoring model 542.

(5) The scoring model 542 is a language model different from the general-purpose LLM 424 and the domain-specific LLM 422, or a similarity-based scoring engine. A determination criterion of the scoring model 542 is at least one of correctness, domain relevance, and fluency.

(6) The processor 102 also functions as a question and correct answer generator 323 that receives an input of the segment to which a data quality label indicating the data quality is attached, generates the question and the correct answer for each segment, and associates the question with the data quality attached to the segment used to generate the question. Therefore, the training data quality evaluation device 310 can generate a question and a correct answer for testing the domain-specific LLM 422.

(7) The data quality identifier includes at least two types of data quality labels including a high quality label and a low quality label.

### First Modification

In the first embodiment described above, instead of the question and correct answer generator 323 executed by the processor 102, a human may generate a question and an answer based on the segment, and input the question and answer from the user IO device 116 to the data quality evaluation application 150 via the terminal IF 112. In addition, instead of the scoring model 542 executed by the processor 102, an answer of the evaluation target LLM 332 may be scored by a human reviewer, and the scoring result may be input from the user IO device 116 to the data quality evaluation application 150 via the terminal IF 112.

### Second Modification

In the first embodiment described above, the scoring device 550 summarizes the scores based on the data quality label output from the QAL database 335. However, the scoring device 550 may independently determine a data quality label instead of the data quality label output from the QAL database 335. For example, the scoring device 550 may independently determine a data quality label through at least one of a rule-based system, a machine learning system, or a large language model.

(8) The data quality label associated with the question is selectively assigned by independently determining the data quality label through at least one of a rule-based system, a machine learning system, or a large language model instead of the data quality attached to the segment used to generate the question.

### Third Modification

In the first embodiment described above, only two data quality labels, high quality and low quality, are used. However, other data quality labels may be set. For example, the identifier 530 may set five data quality labels: “short sentence”, “bullet point”, “repeated word”, “natural sentence in rich context”, and “others”.

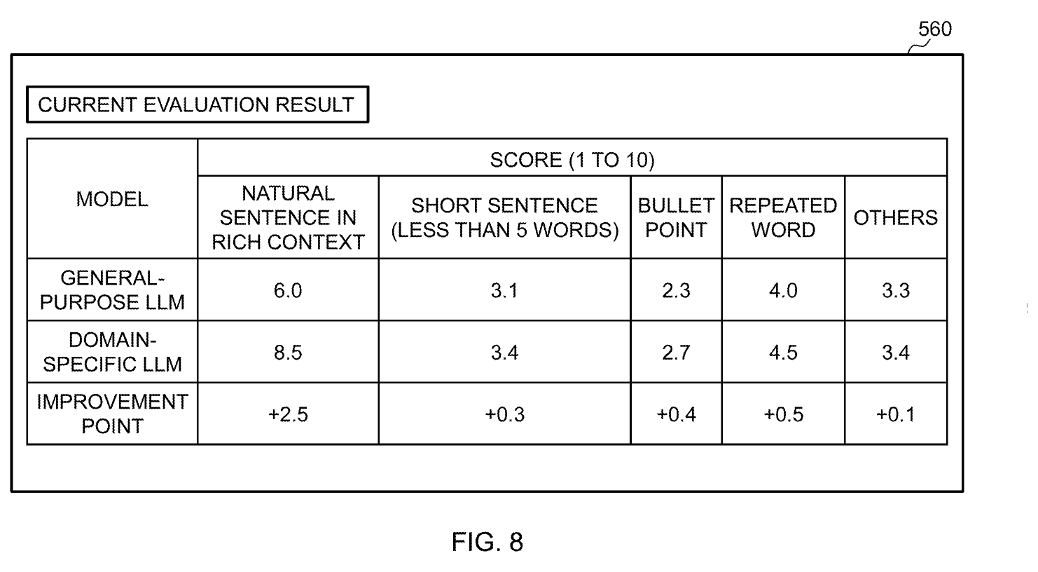

FIG. 8 is a diagram illustrating a display provided by the evaluation display unit 560 in the present modification. In this example, the five data quality labels are illustrated, with scores for the general-purpose LLM 424 and the domain-specific LLM 422 displayed for each data quality label. In addition, a point improved by additional training is indicated for each data quality label.

Further, the identifier 530 may set a plurality of data quality labels to one segment. For example, in a case where a certain segment is a short sentence and is also a bullet point, two data quality labels, "short sentence" and "bullet point", may be set to the segment.

According to the present modification, the following advantageous effects can be obtained.
(9) The processor 102 assigns a plurality of data quality labels based on textual characteristics including short sentence, bullet point, repeated word, and natural sentence in rich context. Therefore, the domain-specific data 402 can be evaluated in multiple ways.

Further, the data quality label may be set based on a plurality of textual characteristics, such as "short sentence", "bullet point", "repeated word", and "natural sentence in rich context", rather than one selected textual characteristic. For example, a high-quality data quality label may be set not only to a segment having the characteristic "natural sentence in rich context" but also to a segment having both the characteristics "short sentence" and "bullet point".

According to the present modification, the following advantageous effects can be obtained.
(10) The processor 102 assigns the high quality label or the low quality label based on one or more textual characteristics including at least one of short sentence, bullet point, repeated word, and natural sentence in rich context.

### Fourth Modification

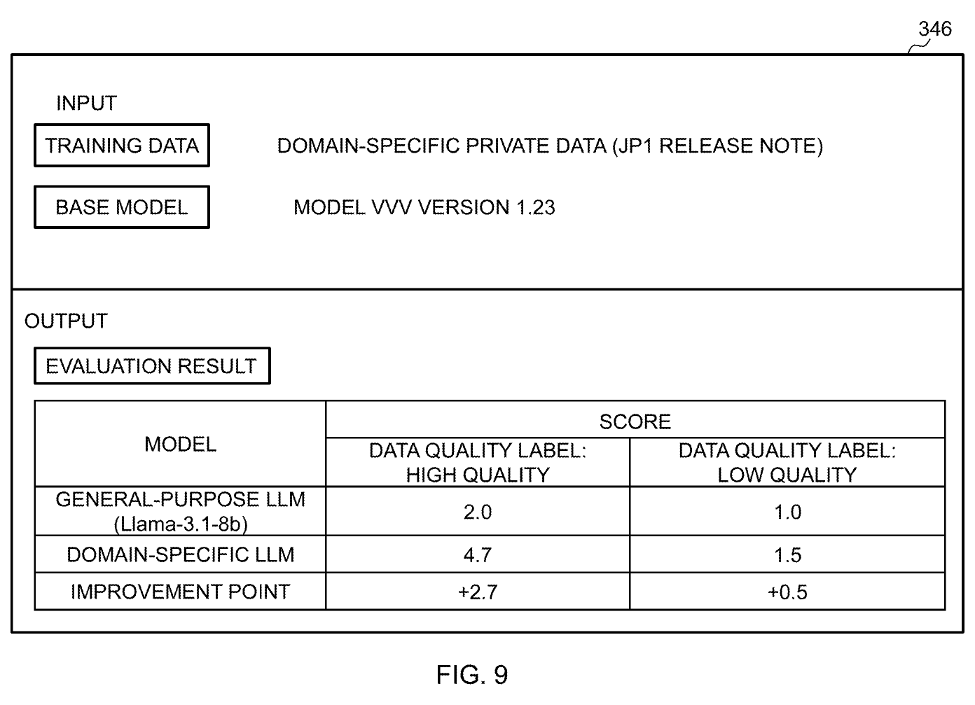

FIG. 9 is a diagram illustrating an example of an output of the evaluation display unit 560 in the fourth modification. In the first embodiment described above, the general-purpose LLM 424 and the domain-specific data 402 are set in advance. However, the general-purpose LLM 424 and the domain-specific data 402 may be selected by the user. For example, the user can specify a selection of the general-purpose LLM 424 and the domain-specific data 402 to the data quality evaluation application 150 via the user IO device 116 and the terminal IF 112. In this case, the evaluation display unit 560 may display not only the evaluation score 334 but also names and the like of the general-purpose LLM 424 and the domain-specific data 402 selected by the user.

### Fifth Modification

The data quality labels are not limited to those described above. For example, four categories may also be assumed: sentence style, fact and trivia, educational value, and required expertise. Each of these categories can be defined as an even higher or lower quality. For the sentence style, a narrative sentence style can be defined as a high quality, while the other styles can be defined as a low quality. For fact and trivia, data including facts and new corroborating information can be defined as a high quality, while the opposite can be defined as a low quality. For educational value, data that is easy for students to understand, that is, step-by-step information, can be defined as a high quality, while the opposite can be defined as a low quality. For required expertise, data that can be understood by ordinary people who are not experts can be defined as a high quality, while the opposite can be defined as a low quality.

### Second Embodiment

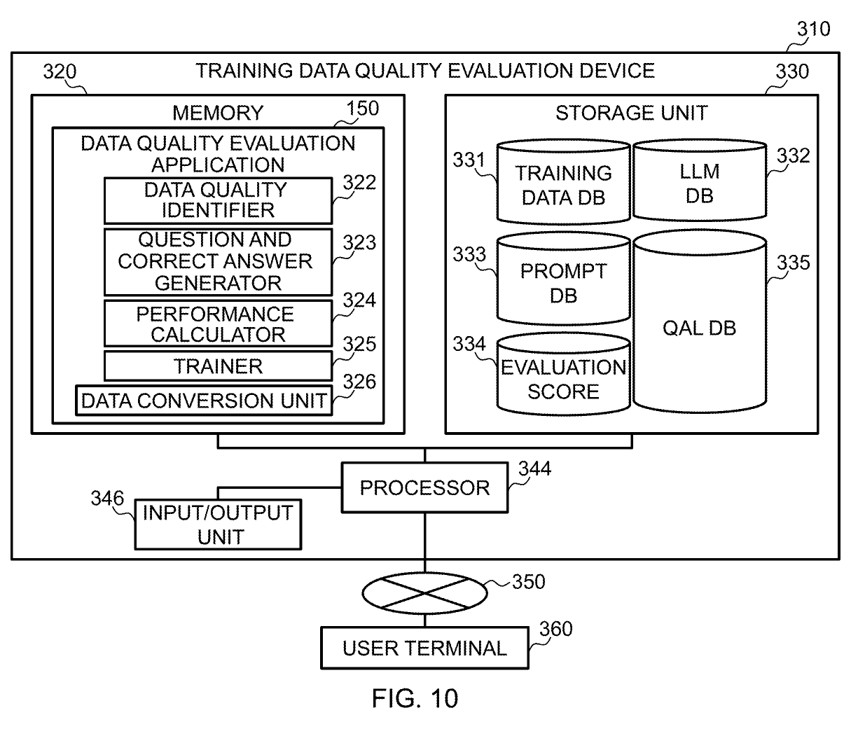

A training data quality evaluation device according to a second embodiment will be described with reference to FIGS. 10-14. In the following description, the same components as those in the first embodiment are denoted by the same reference signs, and differences will be mainly described. The points that are not specifically described are the same as those in the first embodiment. The present embodiment is different from the first embodiment mainly in that the quality of domain-specific data 402 is improved.

FIG. 10 is a diagram illustrating an example of a configuration of a training data quality evaluation system 300 in the second embodiment. The difference from the first embodiment is that the data quality evaluation application 150 stored in the memory 320 further includes a data conversion unit 326.

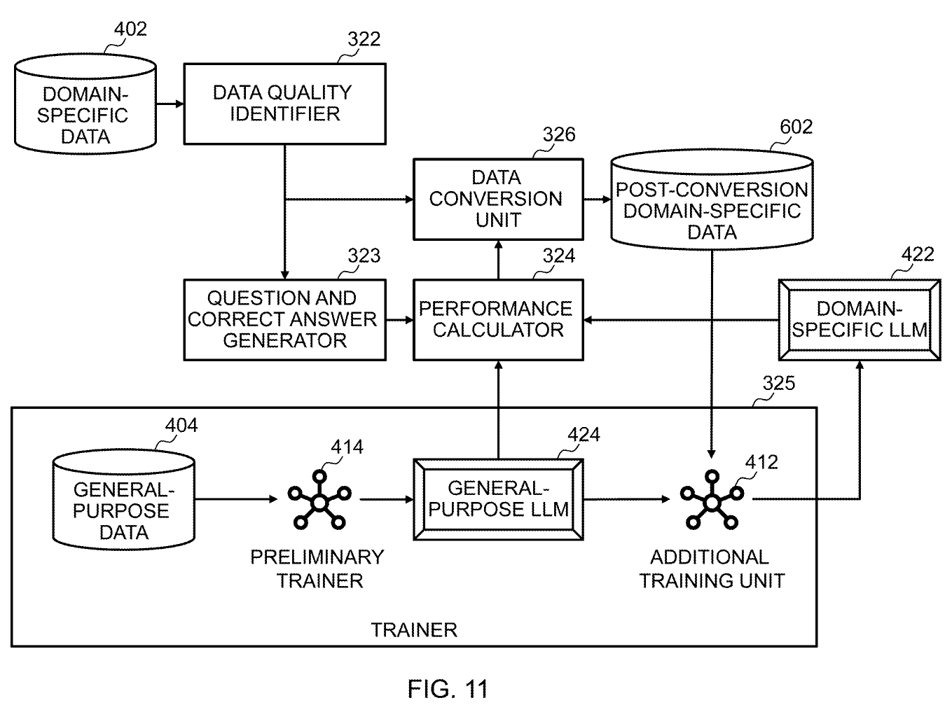

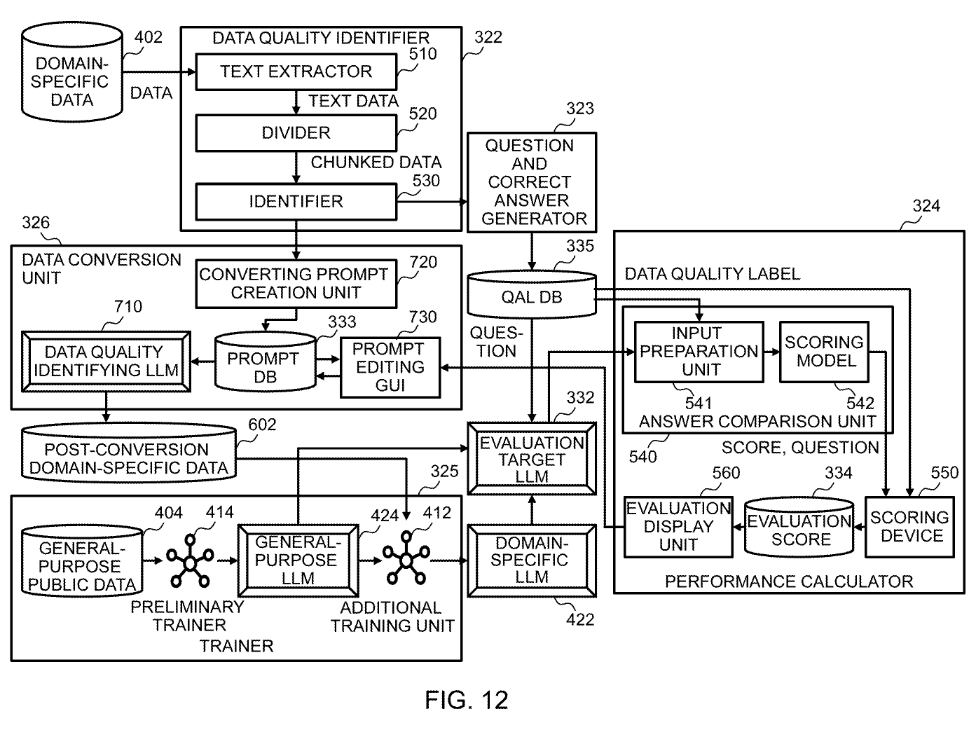

FIG. 11 is a diagram illustrating an outline operation of the data quality evaluation application 150 in the second embodiment, and FIG. 12 is a diagram illustrating a detailed operation of the data quality evaluation application 150 in the second embodiment. The data conversion unit 326 will be described with reference to these drawings.

Using feedback from the performance calculator 324, the data conversion unit 326 converts the domain-specific data 402 to improve its quality. That is, the data conversion unit 326 converts the domain-specific data 402 into converted domain-specific data 602. The converted domain-specific data 602 is used for additional training. The identifier 530 of the data quality identifier 322 sets a data quality label to each segment, similarly to the first embodiment. The identifier 530 outputs the combination of data quality label and segment set similarly to the first embodiment not only to the question and correct answer generator 323 but also to the data conversion unit 326.

The data conversion unit 326 includes a converting prompt creation unit 720, a prompt editing GUI 730, a prompt database 333, and a data quality identifying LLM 710. The converting prompt creation unit 720 generates a prompt including segmented data and an instruction for conversion. The prompt may be a pre-created template. The prompt may include an instruction to change the processing depending on the value of the data quality label. For example, the prompt is "Please convert data with data quality label "high" using vvv strategy, and convert data with data quality label "low" using qqq strategy. The combination of segment and data quality label is as follows....". The prompt generated by the converting prompt creation unit 720 and the combination of data quality label and segment output by the identifier 530 are stored in the prompt database 333. The user determines a content of the prompt to be changed while referring to the display of the evaluation display unit 560, and edits the prompt by operating the prompt editing GUI 730. The prompt edited by the user is also stored in the prompt database 333.

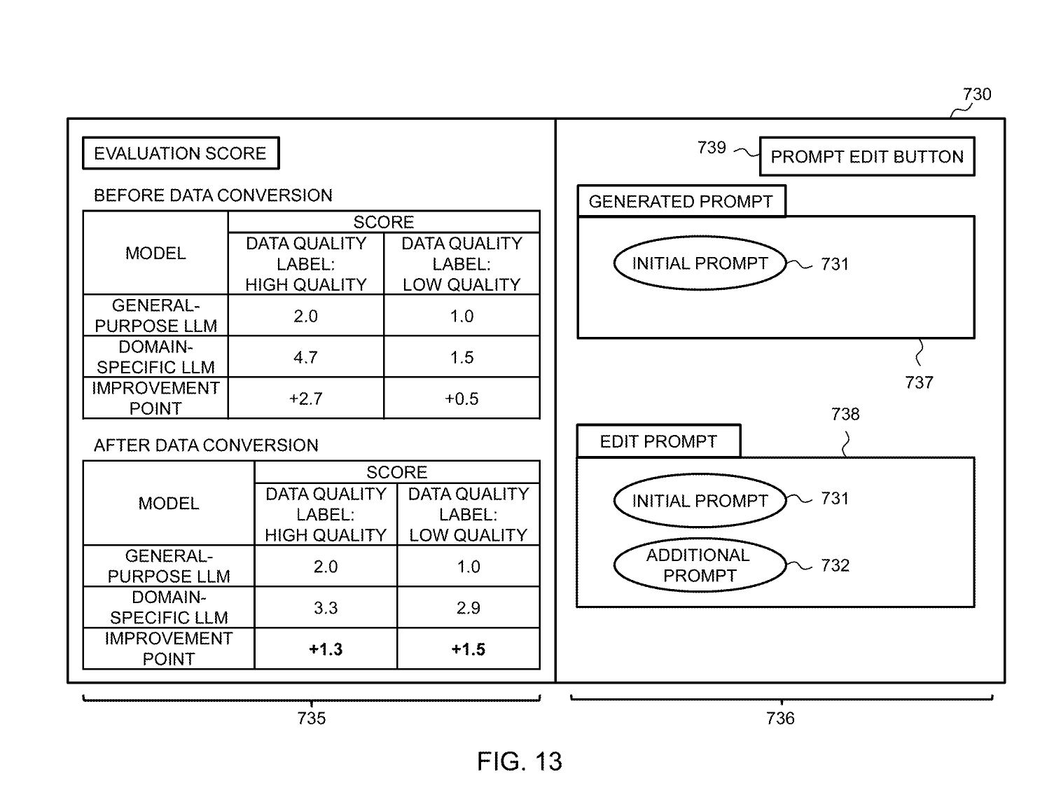

FIG. 13 is a diagram illustrating an example of the prompt editing GUI 730. The prompt editing GUI 730 includes a score display area 735 and a prompt display area 736. Data similar to the output by the evaluation display unit 560 in the first embodiment is displayed in the score display area 735. By looking at the score display area 735, the user can understand that the model can learn knowledge from low-quality data because the improved point for the low-quality data has been improved from +0.5 to +1.5 through data conversion. On the other hand, since the improved point for the high-quality data has decreased from +2.7 to +1.3, it can be seen that the data conversion has a negative effect on learning of knowledge from the high-quality data. Therefore, the user can edit the prompt such that the data conversion does not change the high-quality data.

The prompt display area 736 includes a generated prompt display field 737, an edit prompt display field 738, and a prompt edit button 739. The prompt generated by the converting prompt creation unit 720 is displayed in the generated prompt display field 737. In the description of this drawing, this is referred to as an initial prompt 731. When the user presses the prompt edit button 739, the user is allowed to write to the edit prompt display field 738. Here, the user added an additional prompt 732 without deleting the initial prompt 731.

The initial prompt 731 is, for example, as follows. "In the next step, text will be converted into high-quality data. Ensure that the meaning is preserved and no information is lost during conversion. The data is part of the entire document and will be combined with all converted parts later, so do not change the order of sentences during conversion. Pay close attention to page headers and footers, and consider linking important information, such as product codes and product names in release notes, to the converted data for easier reference. If there is a list, make sure that all elements and information are included. Please generate sentences having a narrative structure and a natural flow of sentences even in a list."

The additional prompt 732 is, for example, as follows. "Minimize editing segments with data quality label "high". Modify segments with data quality label "high" only when necessary to ensure clarity, consistency, and completeness of the final output." When the user fills in the additional prompt 732 and, for example, presses the prompt edit button 739 again, it is determined that the editing of the prompt is completed, and the prompt displayed in the edit prompt display field 738 is output to the prompt DB 333 and the data quality identifying LLM 710.

The data quality identifying LLM 710 is a previously created language model, and converts the domain-specific data 402 into converted domain-specific data 602 according to an input prompt. The combination of data quality label and segment stored in the prompt DB 333 is also input to the data quality identifying LLM 710.

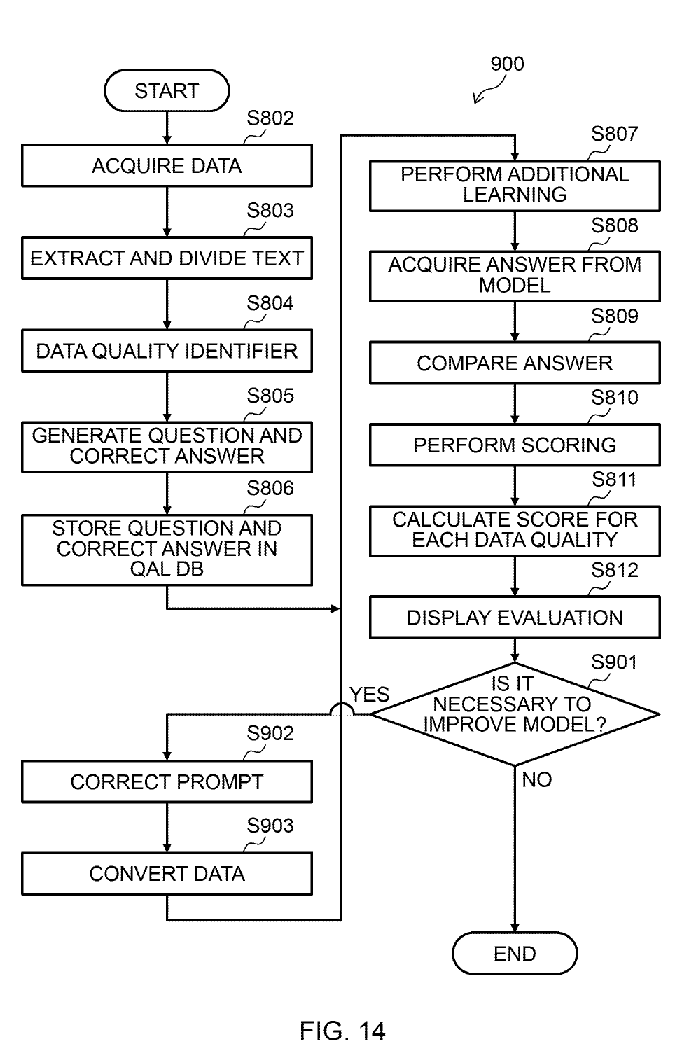

FIG. 14 is a flowchart illustrating processing of the data quality evaluation application 150 in the second embodiment. The processes of steps S802 to S812 are identical to those in FIG. 7 in the first embodiment. A difference between FIGS. 7 and 14 is that steps S901 to S903 are added after step S812. Since the processing up to step S812 is similar to that in the first embodiment, the description thereof will be omitted.

In step S901 executed after step S812, the data conversion unit 326 determines whether it is necessary to improve the model, that is, the domain-specific LLM 422. For example, the data conversion unit 326 may determine whether improvement is necessary depending on whether the evaluation score of the domain-specific LLM 422 exceeds a preset threshold value. In addition, the user may determine whether improvement is necessary by viewing the display provided by the evaluation display unit 560, and input a determination result to the data quality evaluation application 150 via the user IO device 116. The scoring device 550 proceeds to step S902 when it is determined that it is necessary to improve the domain-specific LLM 422, and terminates the processing illustrated in FIG. 14 when it is determined that it is not necessary to improve the domain-specific LLM 422.

In step S902, the data conversion unit 326 receives a correction of the prompt made by the user using the prompt editing GUI 730. In subsequent step S903, the data conversion unit 326 causes the data quality identifying LLM 710 to convert the domain-specific data 402 again using the prompt corrected by the user and generate converted domain-specific data 602, and then returns to step S807. In step S807 to be executed next, additional training is performed using the converted domain-specific data 602 generated in the immediately preceding step S903. This processing is repeated until a negative determination is made in step S901. That is, a series of processes of steps S807 to S812 and S901 to S903 may be repeated multiple times. The above is the description of FIG. 14.

According to the second embodiment described above, the following advantageous effects can be obtained.
(11) The processor 102 converts the domain-specific data 402 based on the evaluation score 334. Therefore, it is possible to improve the domain-specific data 402 so as to increase the effect of the additional training.

(12) The processor 102 generates a prompt including an instruction to convert the segment to a high quality, and inputs the prompt into the data quality identifying LLM 710 to improve the quality of the segment of the domain-specific data 402.

(13) The training data quality evaluation device 310 includes a prompt editing GUI 730 that is a user interface enabling a user to edit the prompt, and an evaluation display unit 560 that presents an evaluation score 334 to the user. Therefore, the user can edit the prompt with reference to the evaluation score 334 displayed on the evaluation display unit 560.

### First Modification of Second Embodiment

In the second embodiment, a human may generate a prompt instead of the converting prompt creation unit 720 of the data conversion unit 326.

### Second Modification of Second Embodiment

The following method may be used for processing the domain-specific data 402. First, low-quality data may be converted into high-quality data using rule-based heuristics. Second, the data may be checked for grammar and structure and corrected to produce natural language text. Third, low-quality complex text may be simplified into high-quality, easy-to-read text using machine reading comprehension (MRC).

The configuration of the functional blocks in each of the above-described embodiments and modifications thereof is merely an example. Some functional configurations illustrated as separate functional blocks may be integrally configured, or a configuration illustrated in one functional block diagram may be divided into two or more functions. In addition, some of the function of each functional block may be included in another functional block.

The above-described embodiments and modifications thereof may be combined together. Although various embodiments and modifications have been described above, the present invention is not limited thereto. Other aspects conceivable within the scope of the technical idea of the present invention also fall within the scope of the present invention.

What is claimed is:

1. A training data quality evaluation device comprising a processor and a memory storing a program to be executed by the processor,
wherein the processor is configured to:
identify a data quality for each segment included in training data;
generate an additionally trained model by additionally training a large language model using the training data;
generate a question and a correct answer using each segment, and associate the question with the data quality of the segment used to generate the question; and
cause the additionally trained model to output an answer to the question, perform scoring by comparing the answer with the correct answer, and create a summary of the scoring.

2. The training data quality evaluation device according to claim 1, wherein
the processor is further configured to convert the training data based on the summary.

3. The training data quality evaluation device according to claim 1, wherein
the processor is further configured to present the summary for each data quality to a user.

4. The training data quality evaluation device according to claim 1, wherein
the processor is further configured to:
generate text data from the training data; and
divide the text data into a plurality of segments;
assign at least one data quality label indicating the data quality for each of the segments.

5. The training data quality evaluation device according to claim 1, wherein
the processor is configured to perform the scoring by inputting the answer and the correct answer to a scoring model.

6. The training data quality evaluation device according to claim 5, wherein
the scoring model is a language model or a similarity-based scoring engine, and
a determination criterion of the scoring model is at least one of correctness, domain relevance, and fluency.

7. The training data quality evaluation device according to claim 1, wherein
the processor is further configured to operate as a question generator that receives an input of the segment to which a data quality label indicating the data quality is attached, generates the question and the correct answer for each segment, and associates the question with the data quality assigned to the segment used to generate the question.

8. The training data quality evaluation device according to claim 7, wherein
the data quality label associated with the question is selectively assigned by independently determining the data quality label through at least one of a rule-based system, a machine learning system, or a large language model instead of the data quality attached to the segment used to generate the question.

9. The training data quality evaluation device according to claim 2, wherein
the processor is further configured to generate a prompt including an instruction to convert the segment to a high quality, and input the prompt into a language model to improve the quality of the segment.

10. The training data quality evaluation device according to claim 9, further comprising:
a user interface that enables a user to edit the prompt; and
a presentation unit that presents an evaluation result to the user.

11. The training data quality evaluation device according to claim 1, wherein
the processor assigns a data quality label indicating the data quality to the segment, and
the data quality label includes at least a high-quality label and a low-quality label.

12. The training data quality evaluation device according to claim 11, wherein
the processor assigns the high-quality label or the low-quality label based on one or more textual characteristics including at least one of short sentence, bullet point, repeated word, and natural sentence in rich context.

13. The training data quality evaluation device according to claim 1, wherein
the processor assigns a plurality of data quality labels each indicating the data quality based on textual characteristics including short sentence, bullet point, repeated word, and natural sentence in rich context.

14. A training data quality evaluation method executed by a training data quality evaluation device including a processor and a memory storing a program to be executed by the processor, the training data quality evaluation method comprising:
identifying a data quality for each of segments included in training data;
generating an additionally trained model by additionally training a large language model using the training data;
generating a question and a correct answer using each segment, and associating the question with the data quality of the segment used to generate the question; and
causing the additionally trained model to output an answer to the question, performing scoring by comparing the answer with the correct answer, and creating a summary of the scoring.

15. A training data quality evaluation system comprising a processor and a memory storing a program to be executed by the processor,
wherein the processor is configured to:
identify a data quality for each segment included in training data;
generate an additionally trained model by additionally training a large language model using the training data;
generate a question and a correct answer using each segment, and associate the question with the data quality of the segment used to generate the question; and
cause the additionally trained model to output an answer to the question, perform scoring by comparing the answer with the correct answer, and create a summary of the scoring.
